(19) United States
(12) Patent Application Publication
(10) Pub. No.: US 2021/0398521 A1
(43) Pub. Date: Dec. 23, 2021

(54) METHOD AND DEVICE FOR PROVIDING VOICE RECOGNITION SERVICE

(71) Applicant: SYSTRAN INTERNATIONAL, Seoul (KR)

(72) Inventors: Myeongjin HWANG, Seoul (KR); Changjin JI, Seoul (KR)

(73) Assignee: SYSTRAN INTERNATIONAL, Seoul (KR)

(21) Appl. No.: 17/291,534

(22) PCT Filed: Nov. 6, 2018
(86) PCT No.: PCT/KR2018/013408

§ 371 Date: May 5, 2021

(51) Int. Cl. G10L 15/08; G10L 15/02; G10L 25/51

(52) U.S. Cl. CPC G10L 15/08; G10L 2015/088; G10L 25/51; G10L 15/02

(57) ABSTRACT

The present invention relates to a method and device for recognizing a voice. More specifically, the voice recognition device according to the present invention may acquire voice information from a user, convert the obtained voice information into voice data, and generate a first voice recognition result by recognizing the converted voice data as a first voice recognition model. Thereafter, the voice recognition device may generate a second voice recognition result by recognizing the converted voice data as a second voice recognition model, compare the first voice recognition result with the second voice recognition result, and select one of the first voice recognition result and the second voice recognition result on the basis of a result of the comparison.

### TECHNICAL FIELD

The present disclosure relates to a method and device for recognizing a voice of a user, and more particularly, to a method and device for improving the reliability of voice recognition in a method of recognizing a voice obtained from a user.

### BACKGROUND ART

Automatic voice recognition (hereinafter, referred to as voice recognition) is a technology that converts a voice into a text using a computer. Such voice recognition has achieved a rapid improvement of recognition rate in recent years.

However, although the recognition rate has improved, there is a problem that words which are not present in the vocabulary dictionary of a voice recognition device may not be still recognized and erroneously recognized (misrecognized) as other vocabularies.

The only way to properly recognize the vocabulary that is not recognized because the vocabulary is not present in the vocabulary dictionary was to add the vocabulary to the vocabulary dictionary.

### DISCLOSURE

### Technical Problem

An object of the present disclosure is to provide a method of preventing a word not in the vocabulary dictionary from being recognized as an unregistered vocabulary by instantly reflecting a vocabulary possessed by a user when a word not in the vocabulary dictionary of a voice recognizer is input.

In addition, another object of the present disclosure is to provide a method of minimizing the use of computing resources in the process of recognizing words that are not in the vocabulary dictionary instantly reflecting the vocabulary possessed by the user.

Technical objects of the present disclosure may not be limited to the above, and other objects will be clearly understandable to those having ordinary skill in the art from the following disclosures.

### Technical Solution

According to one aspect of the present disclosure, a method of recognizing a voice includes obtaining voice information from a user; convert the obtained voice information into voice data; generating a first voice recognition result by recognizing the converted voice data through a first voice recognition model; generating a second voice recognition result by recognizing the converted voice data through a second voice recognition model; comparing the first voice recognition result and the second voice recognition result; and selecting one of the first voice recognition result and the second voice recognition result based on a comparison result.

In addition, according to the present disclosure, the method may further include generating the second voice recognition model by using at least one of language data of the user or auxiliary language data.

In addition, according to the present disclosure, the auxiliary language data may include context data necessary for recognizing a vocabulary included in the voice information obtained from the user.

In addition, according to the present disclosure, the language data may include a vocabulary list for recognizing a vocabulary included in the voice information obtained from the user.

In addition, according to the present disclosure, each of the first and second voice recognition results may be generated through a direct comparison method or a statistical method.

In addition, according to the present disclosure, when the first voice recognition result is generated through the direct comparison method, the generating of the first voice recognition result may include setting the converted voice data as a first feature vector model; comparing the first feature vector model and a first feature vector of the converted voice data; and generating a first confidence value indicating a degree of similarity between the first feature vector model and the first feature vector based on the comparison result.

In addition, according to the present disclosure, when the second voice recognition result is generated through the direct comparison method, the generating of the second voice recognition result may include setting the converted voice data as a second feature vector model; comparing the second feature vector model and a second feature vector of the converted voice data; and generating a second confidence value representing a degree of similarity between the second feature vector model and the second feature vector based on the comparison result.

In addition, according to the present disclosure, the selecting of one of the first and second voice recognition results based on the comparison result may include comparing the first confidence value and the second confidence value; and selecting a voice recognition result having a higher confidence value between the first confidence value and the second confidence value base on the comparison result.

In addition, according to the present disclosure, when the first voice recognition result is generated through the statistical method, the generating of the first voice recognition result may include configuring a unit of the converted voice data into a first state sequence composed of a plurality of nodes; and generating a first confidence value indicating reliability of voice recognition by using a relationship between first state sequences.

In addition, according to the present disclosure, when the second voice recognition result is generated through the statistical method, the generating of the second voice recognition result may include configuring a unit of the converted voice data into a second sequence composed of a plurality of nodes; and generating a second confidence value representing reliability of voice recognition by using a relationship between second state sequences.

In addition, according to the present disclosure, the selecting of one of the first and second voice recognition results based on the comparison result may include comparing the first confidence value and the second confidence value; and selecting a. voice recognition result having a higher confidence value between the first confidence value and the second confidence value based on the comparison result.

In addition, according to the present disclosure, each of the first and second confidence values may be generated using one of a dynamic time warping (DTW), a Hidden Markov model (HKW), or a neural network.

According to another aspect of the present disclosure, a voice recognition device includes an input unit configured to obtain voice information from a user; and a processor configured to process data transmitted from the input unit, wherein the processor is configured to obtain the voice information from the user, convert the obtained voice information into voice data, recognize the converted voice data through a first voice recognition model to generate first voice recognition result, recognize the converted voice data through a second voice recognition model to generate a second voice recognition result, compare the first voice recognition result and the second voice recognition result, and select one of first and second voice recognition results based on the comparison result.

### Advantageous Effects

According to an embodiment of the present disclosure, misrecognition due to unregistered vocabulary does not occur with respect to a vocabulary provided by a user using a voice recognition service.

In addition, since the scale the vocabulary provided by the user is small, it is possible to minimize computing resources and time required when generating a new voice recognition model.

In addition, the default voice recognition model using a large-scale vocabulary dictionary may reduce computing resources and time required generating new voice recognition model by including user vocabulary in basic language data.

In addition, the embodiments may be compatible with the existing functions for voice recognition, and thus the embodiments may be used in an embedded environment and a server-based environment targeting large-scale users.

In addition, effects obtained by the present disclosure may not be limited to the above, and other effects will be clearly understandable to those having ordinary skill in the art from the following disclosures.

### DESCRIPTION OF DRAWINGS

The accompanying drawings, which are included as a part of the detailed description to aid in understanding of the present disclosure, provide embodiments of the present disclosure, and, together with the detailed description, illustrate the technical features of the present disclosure.

FIG. 1 is a block diagram of a voice recognition device according to an embodiment of the present disclosure.

FIG. 2 is a diagram Illustrating a voice recognition device according to an embodiment of the present disclosure.

FIG. 3 is a flowchart illustrating an example of a voice recognition method according to an embodiment of the present disclosure.

FIG. 4 is a flowchart illustrating another example of a voice recognition method according to an embodiment of the present disclosure.

FIG. 5 is a flowchart illustrating an example of a voice recognition method using a direct comparison method according to an embodiment of the present disclosure.

FIG. 6 is a flowchart illustrating an example of a voice recognition method using statistical method according to an embodiment of the present disclosure.

### DESCRIPTION OF REFERENCE NUMERAL

100: Voice recognition device 110: Input unit
120: Storage unit 130: Control unit
140: Output unit

### BEST MODE

### Mode for Invention

Hereinafter, preferred embodiments of the present disclosure will be described in detail with reference to the accompanying drawings. The detailed description to be disclosed below together with the accompanying drawings is intended to describe exemplary embodiments of the present disclosure, and is not intended to represent the only embodiment of the present disclosure which may be implemented. The following detailed description includes specific details to provide a thorough understanding of the present disclosure. However, those skilled in the art may know that the embodiments of the present disclosure may be implemented without these specific details.

In some cases, in order to avoid obscuring the concept of the present disclosure, well-known structures and devices may be omitted or illustrated in a block diagram which focuses on main functions of each structure and device.

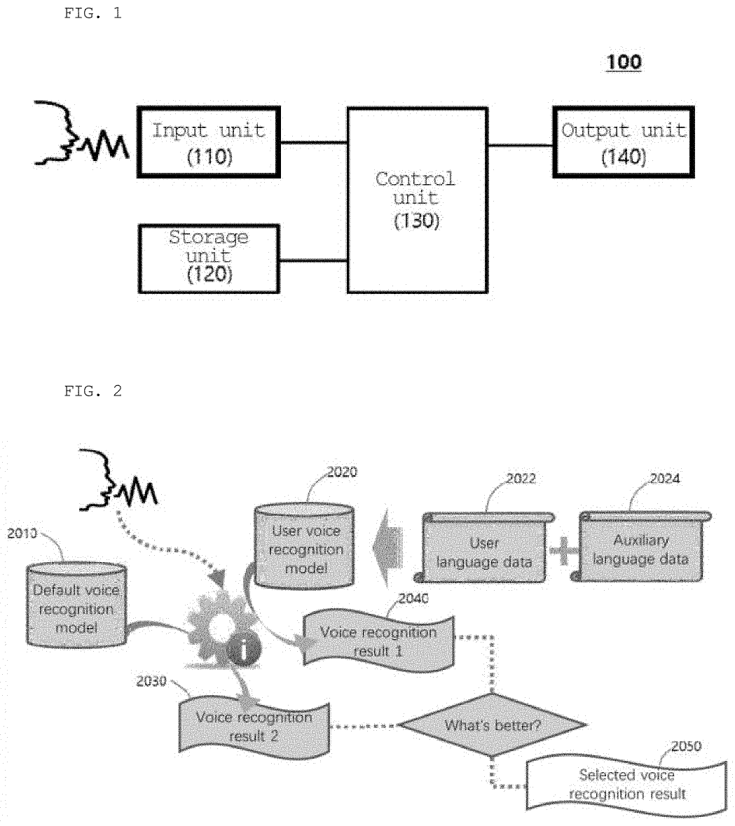

FIG. 1 is a block diagram of a voice recognition device according to an embodiment of the present disclosure.

Referring to FIG. 1, a voice recognition device 100 for recognizing a voce of a user may include an input unit 110, a storage unit 120, a control unit 130, and/or an output unit 140.

Since the components shown in FIG. 1 are not essential, an electronic device having more components or fewer components may be implemented.

Hereinafter, each of the above-mentioned components will be described.

The input unit 110 may receive an audio signal, a video signal, or voice information (or a voice signal) and data from a user.

The input unit 110 may include a camera and a microphone to receive an audio signal or a video signal. The camera processes image frames such as still images or moving pictures obtained by an image sensor in a video call mode or a photographing mode.

The image frames processed by the camera may be stored in the storage unit 120.

The microphone receives an external sound signal in a call mode, a recording mode, or a voice recognition mode and processes the external sound signal as electrical voice data. Various noise removal algorithms may be implemented in the microphone to remove noise generated in the process of receiving an external sound signal.

When an uttered voice of a user is input through a microphone, the input unit 110 converts the voice into an electrical signal and transmits the electrical signal to the control unit 130.

The control unit 130 may obtain voice data of a user by applying a speech recognition algorithm or a speech recognition engine to the signal received from the input unit 110.

In this case, the signal input to the control unit 130 may be converted into a form that is more useful for voice recognition. The control unit 130 may convert the input signal from an analog form to a digital form, and detect the start and end points of the voice to detect the actual voice section/data included in the voice data. This is called end point detection (EPD).

In addition, the control unit 130 may extract a feature vector of a signal by applying feature vector extraction technique such as Cepstrum, linear predictive coefficient (LPC), Mel frequency cepstral coefficient (MFCC), filter bank energy, or the like within a detected section.

The memory 120 may store a program for the operation of the control unit 130 and may temporarily store input/output data. A sample file for a symbol-based malicious code detection model from the user may be stored, and an analysis result of a malicious code may be stored.

The memory 120 may store various data related to the recognized voice, and in particular, may store information and feature vectors related to an end point of the voice data processed by the control unit 130.

The memory 120 may include at least one storage medium such as a flash memory, a hard disc, a memory card, read-only memory (ROM), a random access memory (RAM), an electrically erasable programmable ROM (EEPROM), a programmable ROM (PROM), a magnetic memory, a magnetic disk, and an optical disk.

In addition, the control unit 130 may obtain a recognition result by comparing the extracted feature vector with a trained reference pattern. To this end, a voice recognition model for modeling and comparing signal characteristics of a voice and a language model for modeling a linguistic order relationship of words or syllables corresponding to a recognized vocabulary may be used.

The voice recognition model may be classified into a direct comparison method that sets the recognition target as a feature vector model and compares it with the feature vector of voice data, an a statistical method that uses the feature vector of the recognition target by statistically processing the feature vector.

According to the direct comparison method, units such as words and phonemes serving as a recognition target are set as a feature vector model and similarity between the input voice and the units are compared. For instance, there is a vector quantization method. According to vector quantization method, a feature vector of input voice data is mapped with a codebook, which is a reference model, and encoded as a representative value, thereby comparing the code values with each other.

The statistical model method is a method of configuring the unit for a recognition target as a state sequence and using the relationship between the state sequences. The state sequence may include a plurality of nodes. The method of using the relationship between state sequences may include dynamic time warping (DTW), a hidden Markov model (HMM), a method using a neural network, etc.

The dynamic time warping (DTW) is a method of compensating for a difference in the time axis compared to the reference model in consideration of the dynamic characteristics of the voice having a signal length that varies over time even if the same person makes the same pronunciation. The hidden Markov model is a recognition technique that assumes a voicethrough a Markov process with the state transition probability and the observation probability of a node (an output symbol) in each state, estimates the state transition probability and the observation probability of the node through learning data, and calculates the probability of generating an input voice from the estimated model.

Meanwhile, a language model for modeling linguistic order relationships words or syllables may reduce acoustic ambiguity and recognition errors by applying the order relationship between units constituting a language to units obtained from voice recognition. A language model includes a statistical language model and a model based on finite state automata (FSA) where the statistical language model uses a chain probability of words such as Unigram, Bigram, Trigram, etc.

The control unit 130 may use any of the above-described methods in recognition of the voice. For example, a voice recognition model to which the hidden Markov model is applied may be used, or an N-best search method in which a voice recognition model and a language model are integrated may be used. The N-best search method may improve recognition performance by selecting up to N recognition result candidates using a voice recognition model and a language model, and then re-evaluating the ranking of the candidates.

The control unit 130 may calculate a confidence score (which may be abbreviated as “confidence”) the reliability of the recognition result.

The confidence score is a measure representing the reliability of the result for a voice recognition, and may be defined as a relative value for the probability of uttering a speech from other phonemes or words instead of a phoneme or word obtained by recognition. Therefore, the confidence score may be expressed as a value between 0 and 1, or between 0 and 100. When the confidence score is greater than a preset threshold, the recognition result is accepted, and when the confidence score is less than the preset threshold, the recognition result may be rejected.

In addition, the confidence score may be obtained according to various conventional confidence score acquisition algorithms.

The control unit 130 may be implemented in a computer-readable recording medium by using software, hardware, or a combination thereof. According to hardware implementation, the control unit 130 may be implemented using at least one of electrical units such as application specific integrated circuits (ASICs), digital signal processors (DSPs), digital signal processing devices (DSPDs), programmable logic devices (PLDs), field programmable gate arrays (FPGAs), processors, microcontrollers, micro-processors, etc.

According to the software implementation, it may be implemented together with a separate software module that performs at least one function or operation, and the software code may be implemented by a software application written in an appropriate programming language.

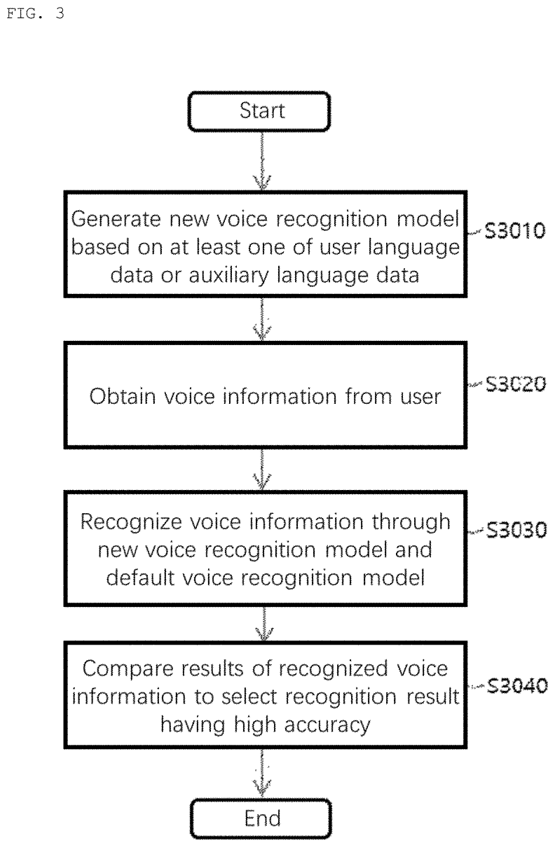

The control unit 130 implements the functions, processes, and/or methods proposed in FIGS. 2 to 6 to be described later. Hereinafter, for convenience of explanation, the description will be made based on the assumption that the control unit 130 is identical to the voice recognition device 100.

The output unit 140 is for generating output related to vision, hearing, etc., and outputs information processed by the device 100.

For example, the output unit 140 may output a recognition result of the voice signal processed by the control unit 130 such that the user can visually or audibly recognize the recognition result.

FIG. 2 is a diagram illustrating a voice recognition device according to an embodiment of the present disclosure.

Referring to FIG. 2, the voice recognition device may recognize a voice signal input from a user through two voice recognition models, and provide a voice recognition service by using one the results recognized through two voice recognition models according to the recognition result.

In detail, the voice recognition device may basically recognize voice data through a default voice recognition model (or a first voice recognition model 2010) and/or a user voice recognition model (or a second voice recognition model 2020), respectively.

In this case, the user voice recognition model 2020 may be immediately generated when user language data 2022 are provided, and auxiliary language data 2024 may be used to generate the user voice recognition model 2020.

The user language data 2022 may include a vocabulary list or a document that may be provided by a user.

The auxiliary language data 2024 may include context data necessary to recognize a vocabulary provided by a user. For example, when the voice signal input from a user is “Tell me the address of Hong Gil-bong”, “Hong Gil-dong” may be included. in the user language data 2022, and “Tell me the address” may be included in the auxiliary language data 2024.

The voice recognition device may use each of the default voice recognition model and the user voice recognition model to obtain two voice recognition results (voice recognition result ‘1’ 2040) and voice recognition result ‘2’ 2030 from the voice data converted from the voice signal input from the user.

The voice recognition device may compare the voice recognition result ‘1’ 2040 and the voice recognition result 2030 to select a voice recognition result 2050 having a higher reliability.

In this case, various methods may be used as a method for selecting a voice recognition result having a high reliability.

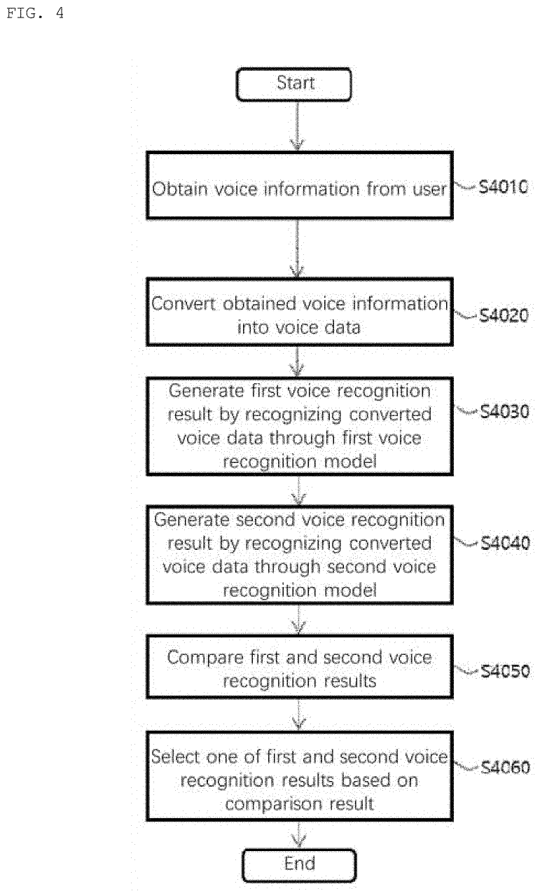

FIG. 3 is a flowchart illustrating an example of a voice recognition method according to an embodiment of the present disclosure.

Referring to FIG. 3, the voice recognition device may recognize a voice of a user through an existing voice recognition model and a newly created voice recognition model, and may provide a voice recognition service by using a highly reliable voice recognition result among the recognized results.

In detail, the voice recognition device may generate a new voice recognition model (a second voice recognition model) based on at least one of the user language data and the auxiliary language data in operation S3010.

When the user language data is obtained from a user or from an outside, the second voice recognition model may be immediately generated based on the obtained user language data and/or auxiliary language data.

Thereafter, when voice information is obtained from the user, in operation S3020, the voice recognition device may convert the obtained voice information into an electric signal, and convert the analog signal, which is the converted electric signal, into a digital signal to generate voice data.

Thereafter, in operation S3030, the voice recognition device may recognize the voice data using the second voice recognition model and the default voice recognition model (first voice recognition model) generated and stored by an existing voice recognition device.

In this case, each of the first and second voice recognition models may recognize voice data through the method described with reference to FIGS. 1 and 2.

Thereafter, in operation S3040, the voice recognition device may compare the recognition results of the voice data recognized through the first and second voice recognition models, and may select a recognition result having higher reliability of the recognized voice information based on the comparison result, thereby providing a voice recognition service to the user.

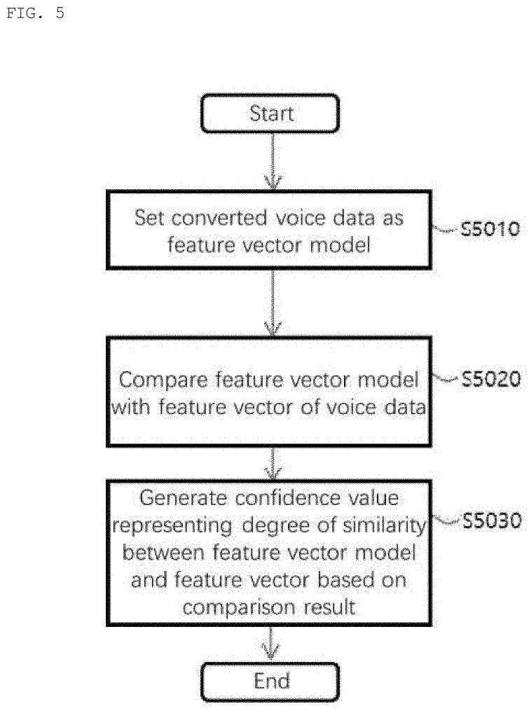

FIG. 4 is a flowchart illustrating another example of a voice recognition method according to an embodiment of the present disclosure.

Referring to FIG. 4, a voice recognition device may recognize voice information (or a voice signal) input from a user through two or more voice recognition models to derive a highly reliable voice recognition result.

In detail, when the voice recognition device obtains voice information from a user in operation S4010, the voice recognition device may convert the obtained voice information into voice data which is a digital signal in operation S4020.

That is, the voice recognition device may convert the obtained voice information into an electrical signal, and then, convert an analog signal, which is the converted electrical signal, into a digital signal to obtain voice data.

Thereafter, in operation S4030, the voice recognition device may generate a first voice recognition result by recognizing the converted voice data through first voice recognition model.

The first voice recognition model may be the default voice recognition model described with reference to FIGS. 1 and 3, and may be a basically stored voice recognition model for providing a voice recognition service.

In addition, in operation S4040, the voice recognition device may recognize the converted voice data through a second voice recognition model to generate a second voice recognition result.

The second voice recognition model may be the new voice recognition model described in FIGS. 1 and 3, and may be generated through at least one of user language data and/or auxiliary language data.

In this case, first and second voice recognition results may be generated through the direct comparison method or the statistical method described with reference to FIG. 1.

Thereafter, in operation S4060 the voice recognition device may compare the first and second voice recognition results with each other, and may provide a voice recognition service by selecting one of the first and second voce recognition results based on the comparison result.

When such a method is used, it is possible to recognize the voice signal obtained from a user through a plurality of voice recognition models instead of a single voice recognition model, and use a voice recognition result having the highest reliability based on the recognized result. Therefore, the reliability of voice recognition is improved.

In addition, a voice recognition model is generated by using the language data of a user, so that it is possible to reduce user computing resources and time required.

Hereinafter, a method of generating a voice recognition result through a direct comparison method or a statistical method will be described.

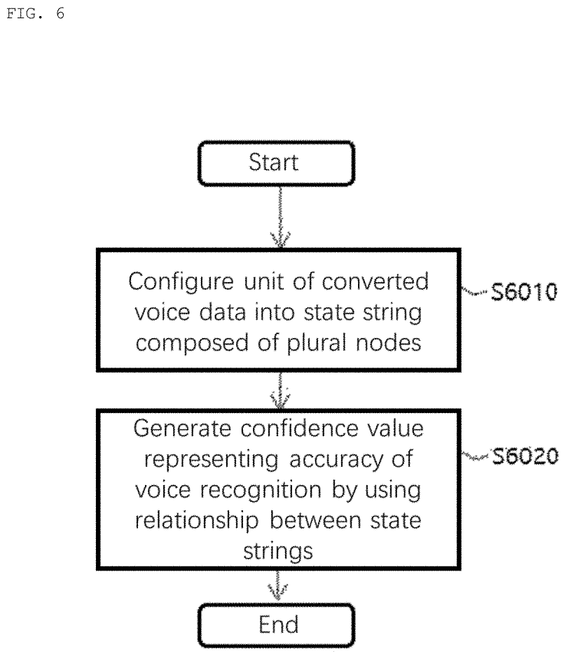

FIG. 5 is a flowchart illustrating an example of a voice recognition method using a direct comparison method according to an embodiment of the present disclosure.

Referring to FIG. 5, the voice recognition device may recognize voice data, which is obtained from a user and converted, by using the direct comparison method of the voice recognition model described in FIG. 1.

In detail, in operation S5010, the voice recognition device may set the voice data converted using each of the first and second voice recognition models as a feature vector model (first and second feature vector models), and generate a feature vector (first and second feature vectors) from the voice data.

Thereafter, in operations S5020 and S5030, the voice recognition device may compare the feature vector model and the feature vector to generate confidence values (first and second confidence values) representing the degree of similarity between the feature vector model and the feature vector.

When the generated confidence value is greater than a preset threshold value, the voice recognition device may recognize that the recognized result is reliable.

However, when the confidence value is less than a preset threshold value, it may be determined that recognized result is unreliable, and the recognized result may be rejected or dropped.

Thereafter, the voice recognition device may provide a voice recognition service by comparing the first and second confidence values with each other to select a voice recognition result having a higher confidence value.

FIG. 5 is a flowchart illustrating an example of a voice recognition method using a direct comparison method according to an embodiment of the present disclosure.

Referring to FIG. 5, the voice recognition device may recognize voice data, which is obtained from a user and converted, by using a statistical method of a voice recognition model described in FIG. 1.

In detail, in operation S6010, the voice recognition device may form a unit for voice data converted using the first and second voice recognition models of a state sequence (first and second state sequences) including a plurality of nodes.

Thereafter, in operation S6020, the voice recognition device may generate a confidence value (first and second confidence values) representing the reliability of voice recognition by using the relationship between the state sequences through a method such as dynamic time warping, a Hidden Markov model, or a neural network.

Thereafter, the voice recognition device may provide voice recognition service by comparing the first and second confidence values with each other to select a voice recognition result having a higher reliability value.

An embodiment according to the present disclosure may be implemented with various means, for example, hardware, firmware, software, or a combination thereof. In the case of implementation with hardware, an embodiment of the present disclosure may be implemented with one or more application specific integrated circuits (ASIC), digital signal processors (DSPs), digital signal processing devices (DSPDs), programmable logic devices (PLDs), field programmable gate arrays (FPGAs), control units, controllers, microcontrollers, micro-control units, etc.

In the case of implementation with firmware or software, an embodiment of the present disclosure may be implemented in the form of a module, procedure, or function that performs the functions or operations described above. The software code may be stored in a memory and may be driven by a control unit. The memory may be located inside or outside the control unit, and may exchange data with the control unit through various known means.

It is obvious to those skilled in the art that the present disclosure can be embodied in other specific forms without departing from the essential features of the present disclosure. Therefore, the above detailed description should not be construed as restrictive in all respects and should be considered as illustrative. The scope of the present disclosure should be determined by rational interpretation of the appended claims, and all changes within the equivalent scope of the present disclosure are included in the scope of the present disclosure.

### INDUSTRIAL APPLICABILITY

The present disclosure may be applied to various fields of voice recognition technology. The present disclosure provides a method of providing a high-reliable voice recognizer that consumes a small amount of computing resources in a short model generation time. Due to the above features of the present disclosure, it may be used in an embedded form such as a smart phone with weak computing power. In addition, the present disclosure may be used as a server-type high-performance user-customized voice recognition service for large-scale users due to the above features. Such features may be applied not only to voice recognition, but also to other artificial intelligence services.

1. A method of recognizing a voice, the method comprising:
obtaining voice information from a user;
converting the obtained voice information into voice data;
generating a first voice recognition result by recognizing the converted voice data through a first voice recognition model;
generating a second voice recognition result by recognizing the converted voice data through a second voice recognition model;
comparing the first voice recognition result and the second voice recognition result; and
selecting one of the first voice recognition result and the second voice recognition result based on a comparison result.

2. The method of claim 1, further comprising:
generating the second voice recognition model by using at least one of language data of the user or auxiliary language data.

3. The method of claim 2, wherein the auxiliary language data includes context data necessary for recognizing a vocabulary included in the voice information obtained from the user.

4. The method of claim 2, wherein the language data includes a vocabulary list for recognizing a vocabulary included in the voice information obtained from the user.

5. The method of claim 1, wherein each of the first and second voice recognition results is generated through a direct comparison method or a statistical method.

6. The method of claim 5, wherein, when the first voice recognition result is generated through the direct comparison method, the generating of the first voice recognition result includes:
setting the converted voice data as a first feature vector model;
comparing the first feature vector model and a first feature vector of the converted voice data; and
generating a first confidence value indicating a degree of similarity between the first feature vector model and the first feature vector based on the comparison result.

7. The method of claim 6, wherein, when the second voice recognition result is generated through the direct comparison method, the generating of the second voice recognition result includes:
setting the converted voice data as a second feature vector model;
comparing the second feature vector model and a second feature vector of the converted voice data; and
generating a second confidence value representing a degree of similarity between the second feature vector model and the second feature vector based on the comparison result.

8. The method of claim 7, wherein the selecting of one of the first and second voice recognition results based on the comparison result includes:
comparing the first confidence value and the second confidence value; and
selecting a voice recognition result having a higher confidence value between the first confidence value and the second confidence value based on the comparison result.

9. The method of claim 5, wherein, when the first voice recognition result is generated through the statistical method, the generating of the first voice recognition result includes:
configuring a unit of the converted voice data into a first state sequence composed of a plurality of nodes; and
generating a first confidence value indicating reliability of voice recognition by using a relationship between first state sequences.

10. The method of claim 6, wherein, when the second voice recognition result is generated through the statistical method, the generating of the second voice recognition result includes:
configuring a unit of the converted voice data into a second sequence composed of a plurality of nodes; and
generating a second confidence value representing reliability of voice recognition by using a relationship between second state sequences.

11. The method of claim 10, wherein the selecting of one of the first and second voice recognition results based on the comparison result includes:
comparing the first confidence value and the second confidence value; and
selecting a voice recognition result having a higher confidence value between the first confidence value and the second confidence value based on the comparison result.

12. The method of claim 11, wherein each of the first and second confidence values is generated using one of a dynamic time warping (DTW), a Hidden Markov model (HMW), or a neural network.

13. A voice recognition device comprising:
an input unit configured to obtain voice information from a user; and
a processor configured to process data transmitted from the input unit,
wherein the processor is configured to:
obtain the voice information from the user, convert the obtained voice information into voice data,
recognize the converted voice data through a first voice recognition model to generate a first voice recognition result,
recognize the converted voice data through a second voice recognition model to generate a second voice recognition result,
compare the first voice recognition result and the second voice recognition result, and
select one of the first and second voice recognition results based on the comparison result.
